(19) United States
(12) Patent Application Publication
(10) Pub. No.: US 2026/0035101 A1
(43) Pub. Date: Feb. 5, 2026

(54) VEHICLE FOR TOWING AIRCRAFT

(71) Applicant: Oshkosh Corporation, Oshkosh, WI (US)

(72) Inventors: William Lunt, Oshkosh, WI (US); Chris Colvin, Oshkosh, WI (US)

(73) Assignee: Oshkosh Corporation, Oshkosh, WI (US)

(21) Appl. No.: 19/286,651

(22) Filed: Jul. 31, 2025

Related U.S. Application Data
(60) Provisional application No. 63/678,116, filed on Aug. 1, 2024.

(51) Int. Cl. B64F 1/228; B64F 1/227

(52) U.S. Cl. CPC B64F 1/228; B64F 1/227

(57) ABSTRACT

A vehicle for towing an airplane having a nose gear includes a chassis, a front tractive assembly, a rear tractive assembly, wherein at least one of the front tractive assembly or the rear tractive assembly is a steerable tractive assembly, a driveline configured to drive and brake at least one of the front tractive assembly or the rear tractive assembly, a capture system configured to engage with the nose gear, and a control system configured to monitor a current speed of the vehicle, determine a steering angle of the steerable tractive assembly, and limit operation of the vehicle based on the current speed and the steering angle.

### CROSS-REFERENCE TO RELATED PATENT APPLICATION

This application claims the benefit of and priority to U.S. Provisional Patent Application No. 63/678,116, filed Aug. 1, 2024, which is incorporated herein by reference in its entirety.

### BACKGROUND

Airplanes are typically towed by a tractor at an airport to reposition the airplane during departure or arrival from a gate, transport the airplane to or from a hangar, or to otherwise move the airplane. Such tractors may provide a large turning angle for its steerable wheels to provide enhanced maneuverability. However, such large turning angle may be misused by operators while at elevated speeds.

### SUMMARY

One embodiment relates to a vehicle for towing an airplane having a nose gear. The vehicle includes a chassis, a front tractive assembly, a rear tractive assembly, wherein at least one of the front tractive assembly or the rear tractive assembly is a steerable tractive assembly, a driveline configured to drive and brake at least one of the front tractive assembly or the rear tractive assembly, a capture system configured to engage with the nose gear, and a control system configured to monitor a current speed of the vehicle, determine a steering angle of the steerable tractive assembly, and limit operation of the vehicle based on the current speed and the steering angle.

Another embodiment relates to a tow vehicle system. The tow vehicle system includes one or more processing circuits configured to monitor a current speed of a tow vehicle configured to tow an airplane having a nose gear, the tow vehicle including a steerable tractive assembly and a driveline configured to drive and brake the tow vehicle, determine a steering angle of the steerable tractive assembly, and control the driveline to dynamically limit or reduce a maximum speed of the tow vehicle based on the current speed and the steering angle.

Still another embodiment relates to a vehicle for towing an airplane having a nose gear. The vehicle includes a chassis, a front tractive assembly, a rear tractive assembly, wherein at least one of the front tractive assembly or the rear tractive assembly is a steerable tractive assembly, a driveline configured to drive and brake at least one of the front tractive assembly or the rear tractive assembly, a capture system configured to engage with the nose gear, and a control system configured to monitor a current speed of the vehicle, determine a steering angle of the steerable tractive assembly, and control the driveline to dynamically limit or reduce a maximum speed of the vehicle based on the current speed and the steering angle.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a tractor towing an airplane, according to an exemplary embodiment.

FIG. 2 is a front, left perspective view of the tractor of FIG. 1, according to an exemplary embodiment.

FIG. 3 is a detailed rear, left perspective view of a seating area of the tractor of FIG. 2, according to an exemplary embodiment.

FIG. 4 is a detailed view of the seating area of FIG. 3, according to an exemplary embodiment.

FIG. 5 is a detailed view of a capture system of the tractor of FIG. 2, according to an exemplary embodiment.

FIG. 6 is a perspective view of the airplane supported by and coupled with the tractor of FIG. 1 using the capture system of FIG. 5, according to an exemplary embodiment.

FIG. 7 is a schematic block diagram of the tractor of FIG. 1, according to an exemplary embodiment.

FIG. 8 is a bottom view of the tractor of FIG. 1 defining a tractor axis and including a tractive assembly defining a wheel axis, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

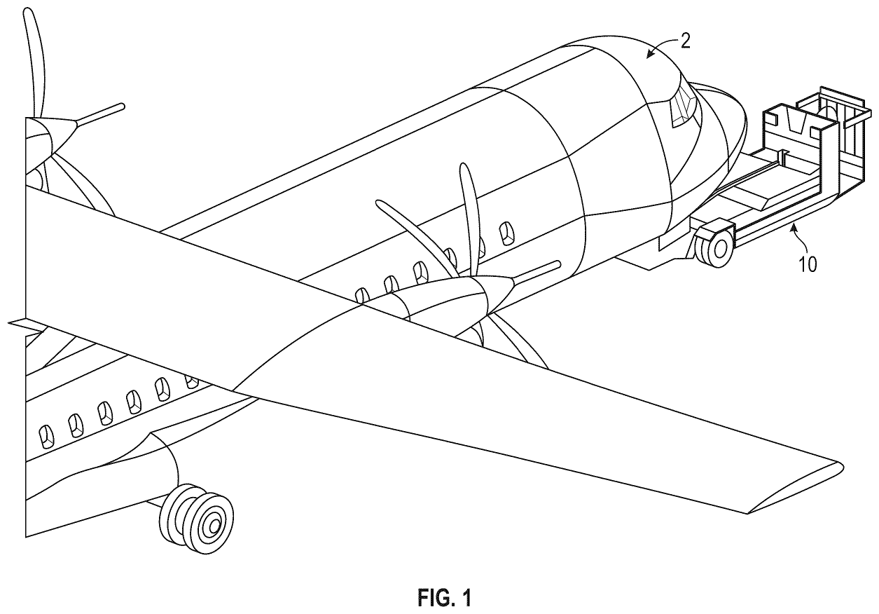

As shown in FIGS. 1-7, a tow vehicle (e.g., an aircraft tow vehicle, a tow-bar-less tow vehicle, an aircraft tractor, etc.), shown as tractor 10, is configured to couple with and support at least a portion (e.g., a nose gear, a landing gear, a nose landing gear, etc.) of an aircraft, show as airplane 2, to tow, pushback, or otherwise manipulate the airplane 2. According to an exemplary embodiment, the tractor 10 is used for one or more operations at an airport including pushing the airplane 2 during pushback operations (e.g., departing from a gate), towing the airplane 2 between locations (e.g., between gates, hangars, fueling areas, maintenance areas, de-icing areas, etc.), positioning the airplane 2 (e.g., into proper alignment at a gate with a bridge), and/or other operations.

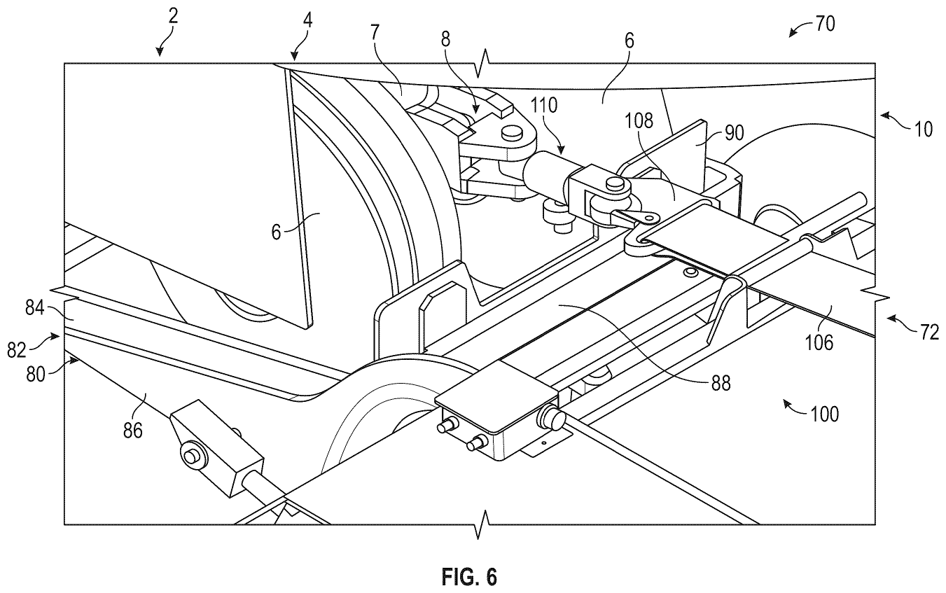

As shown in FIG. 6, the airplane 2 includes a nose gear assembly, shown as nose gear 4. The nose gear 4 includes two tractive elements, shown as wheels 6, and a shaft member (e.g., a strut, post, rod, etc.), shown as pivot 7, coupled between the wheels 6 and a fuselage of the airplane 2. The wheels 6 are rotatably coupled with the pivot 7 and are configured to engage a ground surface (e.g., tarmac, road, etc.). The nose gear 4 is steerable to facilitate steering the airplane 2. In some embodiments, the nose gear 4 includes more or fewer than two wheels 6. As shown in FIG. 6, the nose gear 4 includes a securing element (e.g., a mechanical linkage, a towing adapter, a tow ball, a hook, a tow eye, etc.), shown as tow element 8, coupled with the pivot 7, and configured to facilitate a coupling between the nose gear 4 and the tractor 10 (e.g., the winch-capture system 72). In some embodiments, the nose gear 4 does not include the tow element 8 and coupling between the nose gear 4 and the tractor 10 is accomplished in another manner (e.g., by a coupling between the wheels 6 and the winch-capture system 72 and/or the hands-free capture system 200, directly between the pivot 7 and the tractor 10 by securing a strap around the pivot 7, etc.).

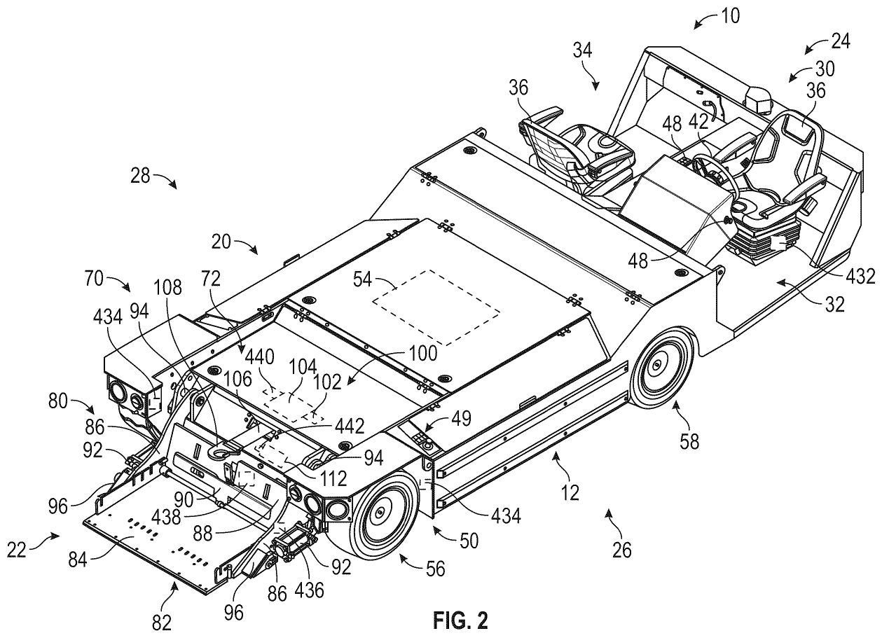

As shown in FIGS. 2-7, the tractor 10 includes a chassis, shown as frame 12; a body assembly, shown as body 20, coupled to the frame 12 and having an occupant portion or section, shown as occupant seating area 30; first operator input and output devices, shown as first operator controls 40, that are disposed within the occupant seating area 30; second operator input and output devices, shown as second operator controls 49, that are disposed outside of the occupant seating area 30; a drivetrain, shown as driveline 50, coupled to and/or supported by the frame 12; a braking assembly, shown as braking system 60, coupled to one or more components of the driveline 50 to facilitate selectively braking the one or more components of the driveline 50; an aircraft capture system, shown as capture system 70, coupled to the frame 12 and/or the body 20; and a control system, shown as tractor control system 400, coupled to the first operator controls 40, the driveline 50, the braking system 60, the capture system 70, and the second operator controls 49. In some embodiments, the tractor 10 includes more or fewer components.

As shown in FIGS. 2, 3, and 5, the tractor 10 has a first end, shown as front end 22, a second end, shown as rear end 24, opposite the front end 22, a first side, shown as left side 26, and a second side, shown as right side 28, opposite the left side 26. According to the exemplary embodiment shown in FIGS. 2-4, the occupant seating area 30 includes a plurality of operator compartments including a first operator compartment, shown as forward travel compartment 32, and a second operator compartment, shown as rearward travel compartment 34. In some embodiments, the occupant seating area 30 includes a third operator compartment positioned forward, rearward, or between the forward travel compartment 32 and the rearward travel compartment 34. In some embodiments, the occupant seating area 30 does not include the rearward travel compartment 34.

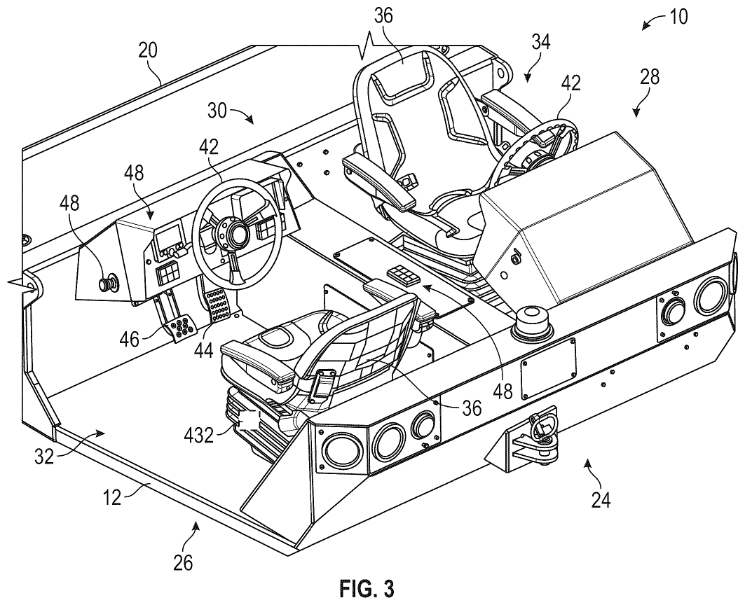

As shown in FIGS. 2-4, each of the forward travel compartment 32 and the rearward travel compartment 34 include an operator seat, shown as seat 36. As shown in FIGS. 2 and 3, the seat 36 of the forward travel compartment 32 is oriented facing the front end 22 such that an operator can control operation of the tractor 10 while facing the front end 22. The seat 36 of the rearward travel compartment 34 is oriented facing the rear end 24 such that an operator can control operation of the tractor 10 while facing the rear end 24. In other embodiments, the forward travel compartment 32 and the rearward travel compartment 34 face the same direction (e.g., in a direction towards the front end 22 or the rear end 24). In some embodiments, the seat 36 of the forward travel compartment 32 and the seat of the rearward travel compartment 34 are movable (e.g., rotatable, repositionable, etc.) to change a direction in which the seats 36 are facing (e.g., depending on a direction of travel of the tractor 10). As shown in FIGS. 2 and 3, the forward travel compartment 32 is positioned along the left side 26 of the tractor 10 and the rearward travel compartment 34 is positioned along the right side 28 of the tractor 10. In other embodiments, the forward travel compartment 32 is positioned along the right side 28 of the tractor 10 and the rearward travel compartment 34 is positioned along the left side 26 of the tractor 10.

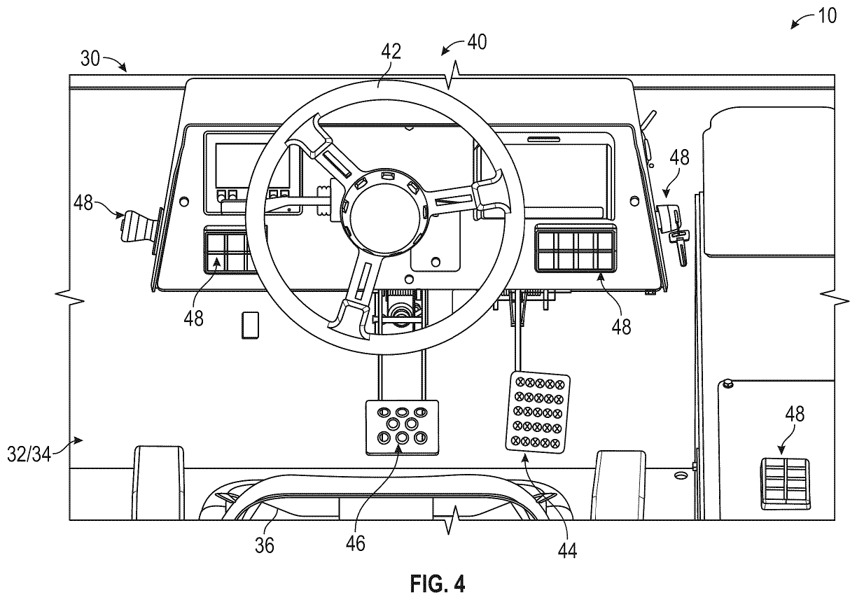

According to an exemplary embodiment, the first operator controls 40 are configured to provide an operator with the ability to control one or more functions of and/or provide commands to the tractor 10 and the components thereof (e.g., turn on, turn off, drive, turn, brake, engage various operating modes, raise/lower the cradle 82 of the cradle assembly 80, payout or take-up the winch strap 106 of the winch-capture system 72, etc.). As shown in FIGS. 3 and 4, the first operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a liquid crystal display (“LCD”), a light emitting diode (“LED”) display, a speedometer, gauges, warning lights, etc. The one or more displays are configured to display information and/or warnings relating to the operation of the tractor 10. The one or more input devices may be or include buttons, switches, knobs, levers, dials, etc.

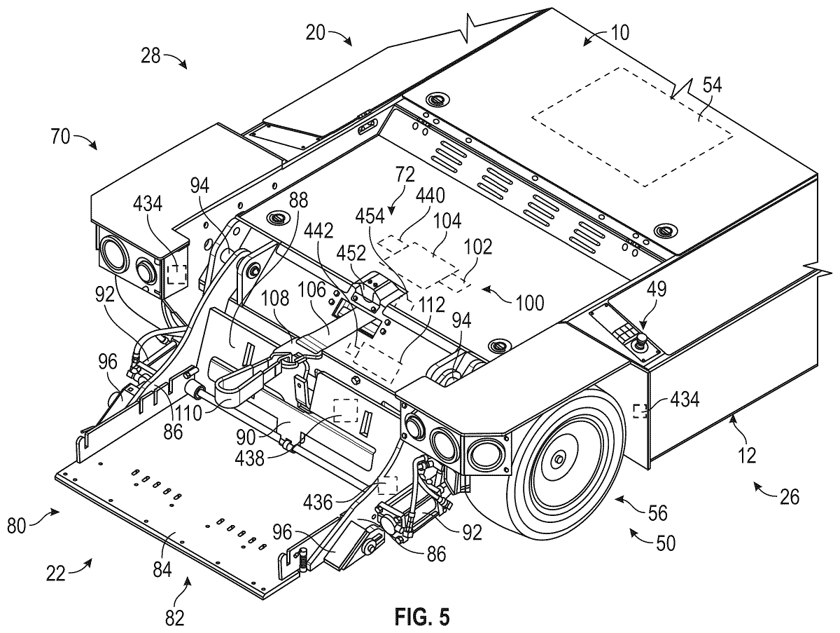

As shown in FIGS. 4 and 5, each of the forward travel compartment 32 and the rearward travel compartment 34 include the first operator controls 40. The first operator controls 40 of the forward travel compartment 32 may be used to control operation of the tractor 10 (e.g., driving, steering, and braking operations, cradle operations, winching operations, etc.) when the tractor 10 is in a first mode of operation (e.g., a forward travel mode, an approach mode, a capture mode, a pushback mode, etc.) and the first operator controls 40 of the rearward travel compartment 34 may be used to control operation of the tractor 10 when the tractor 10 is in a second mode of operation (e.g., a rearward travel mode, a tow mode, a return mode, etc.). In some embodiments, one of the forward travel compartment 32 or the rearward travel compartment 34 does not include the first operator controls 40. In such embodiments, the seats 36 may face the same direction or be replaced with a single, bench-style seat. An operator may provide an input to the first operator controls 40 (e.g., to the operator interface 48) to switch between the first mode of operation in which operation of the tractor 10 is controlled by the forward travel compartment 32 and the second mode of operation in which operation of the tractor 10 is controlled by the rearward travel compartment 34.

According to an exemplary embodiment, the second operator controls 49 are configured to provide an operator with the ability to control one or more functions of and/or provide commands to the tractor 10 and the components thereof (e.g., turn on, turn off, engage various operating modes, raise/lower the cradle 82 of the cradle assembly 80, payout or take-up the winch strap 106 of the winch-capture system 72, operate the hands-free capture system 200, etc.). The second operator controls 49 may include one or more displays and one or more input devices. The one or more displays may be or include a touchscreen, a LCD display, a LED display, a speedometer, gauges, warning lights, etc. The one or more displays are configured to display information and/or warnings relating to the operation of the tractor 10. The one or more input devices may be or include buttons, switches, knobs, levers, dials, etc. As shown in FIGS. 2 and 5, the second operator controls 49 are positioned along an exterior of the body 20 proximate the front end 22 of the tractor 10. The second operator controls 49 are positioned outside of the forward travel compartment 32 and the rearward travel compartment 34, and are separate from the operator interface 48 of the first operator controls 40 such that an operator can control operation of the tractor 10 while positioned outside of the forward travel compartment 32 and the rearward travel compartment 34. The position of the second operator controls 49 makes it easier for the operator to control the capture system 70 because the operator is positioned closer thereto (and therefore, less obstructions are positioned between the operator and the winch-capture system 72 and/or the hands-free capture system 200). In some embodiments, each of the second operator controls 49 and the operator interface 48 control the same components of the tractor 10 (e.g., operation of the braking system 60). Additionally or alternatively, in some embodiments, the second operator controls 49 control a first subset of components of the tractor 10 (e.g., operation of the capture system 70) and the operator interface 48 controls a second subset of components of the tractor 10 (e.g., operation of the driveline 50).

According to an exemplary embodiment, the driveline 50 is configured to propel the tractor 10. As shown in FIGS. 2, 5, and 7, the driveline 50 includes a primary driver, shown as prime mover 52, an energy storage device, shown as energy storage 54, a first tractive assembly (e.g., axles, wheels, tracks, differentials, etc.), shown as front tractive assembly 56, and a second tractive assembly (e.g., axles, wheels, tracks, differentials, etc.), shown as rear tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIGS. 2 and 5, the front tractive assembly 56 includes front tractive elements and the rear tractive assembly 58 includes rear tractive elements that are configured as wheels. In some embodiments, the front tractive elements and/or the rear tractive elements are configured as tracks.

According to an exemplary embodiment, the prime mover 52 is configured to provide power to drive the front tractive assembly 56 and/or the rear tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the front tractive assembly 56 and/or the rear tractive assembly 58. The front tractive assembly 56 and/or the rear tractive assembly 58 may include a drive shaft, a differential, and/or an axle. In some embodiments, the front tractive assembly 56 and/or the rear tractive assembly 58 include two axles or a tandem axle arrangement. In some embodiments, the front tractive assembly 56 and/or the rear tractive assembly 58 are steerable (e.g., using the steering wheel 42). In some embodiments, both the front tractive assembly 56 and the rear tractive assembly 58 are fixed and not steerable (e.g., employ skid steer operations).

In some embodiments, the driveline 50 includes a plurality of prime movers 52. By way of example, the driveline 50 may include a first prime mover 52 that drives the front tractive assembly 56 and a second prime mover 52 that drives the rear tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 56, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 58, a second prime mover 52 that drives a first one of the front tractive elements, and a third prime mover 52 that drives a second one of the front tractive elements.

In some embodiments, the tractor 10 includes a suspension system including one or more suspension components (e.g., shocks, dampers, springs, etc.) positioned between the frame 12 and one or more components (e.g., tractive elements, axles, etc.) of the front tractive assembly 56 and/or the rear tractive assembly 58. In some embodiments, the tractor 10 does not include the suspension system.

According to an exemplary embodiment, the braking system 60 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 56 (e.g., the front axle, the front tractive elements, etc.) and (ii) one or more rear braking components positioned to facilitate braking one or more components of the rear tractive assembly 58 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, the braking system 60 is configured to facilitate braking one or more components of the driveline 50 responsive to an input received from the first operator controls 40. By way of example, responsive to interfacing with (e.g., engaging, depressing, pushing, etc.) the brake 46, the braking system 60 may be configured to facilitate braking one or more components of the driveline 50. By way of another example, responsive to interfacing with (e.g., engaging, pressing, turning, pulling, etc.) one or more input devices of the operator interface 48, the braking system 60 may be configured to engage a parking brake to brake the front tractive elements and/or the rear tractive elements. In such an example, responsive to engaging the parking brake, the one or more displays of the operator interface 48 may provide an indication (e.g., flash a light, play a sound, display a message, play a message, etc.) that the parking brake is engaged. In some embodiments, electric regenerative braking is employed (e.g., via the prime mover 52, an electric motor, etc.) in combination with or instead of using the braking system 60 to facilitate braking of one or more components of the driveline 50. By way of example, the prime mover 52 may be back-driven by the front axle of the front tractive assembly 56 and/or the rear axle of the rear tractive assembly 58 though an axle interface during a braking event.

### Capture System

According to the exemplary embodiment shown in FIGS. 1, 2, 5, and 6, the tractor 10 is configured as a towbarless tractor that couples with the airplane 2 using a “soft-capture” or “winch-capture” system/mechanism. In other embodiments, the tractor 10 is configured as another type of tractor that couples with the airplane 2 using a “hard-capture” or “hands-free” capture system/mechanism. As shown in FIGS. 2, 5, 6, and 7, the capture system 70 includes either (i) a “winch-capture” system/mechanism, shown as winch-capture system 72, or (ii) a “hard-capture” system/mechanism, shown as hands-free capture system 200. According to the exemplary embodiment shown in FIGS. 2, 5, and 6, the tractor 10 is configured as a towbarless tractor that couples with the airplane 2 using the winch-capture system 72.

### Winch-Capture System

As shown FIGS. 2, 5, 6, and 7, the winch-capture system 72 includes a first aircraft support assembly (e.g., bucket assembly, ramp assembly, etc.), shown as cradle assembly 80, and a towing mechanism, shown as winch assembly 100. According to an exemplary embodiment, the winch assembly 100 is configured to engage with the nose gear 4 of the airplane 2 to pull the cradle assembly 80 under the nose gear 4 (or pull the airplane 2 on top of the cradle assembly 80) and the cradle assembly 80 is configured to support the nose gear 4 of the airplane 2 and lift the front end of the airplane 2 to facilitate towing, pushing, or otherwise repositioning the airplane 2 with the tractor 10. By way of example, the cradle assembly 80 is configured to space or lift the nose gear 4 of the airplane 2 from a ground surface and carry the nose gear 4 as the tractor 10 is driven to reposition the airplane 2. As shown in FIGS. 2, 5, and 6, the cradle assembly 80 and the winch assembly 100 are positioned at or proximate the front end 22 of the tractor 10. In some embodiments, the cradle assembly 80 and/or the winch assembly 100 are otherwise positioned about the tractor 10 (e.g., at or proximate the rear end 24).

As shown in FIGS. 2, 5, and 6, the cradle assembly 80 includes an aircraft support (e.g., a bucket, a ramp, etc.), shown as cradle 82, having a support deck, shown as bottom plate 84, side supports (e.g., side gates), shown as sidewalls 86, and a rear support (e.g., rear gate), shown as back wall 88. Collectively, the bottom plate 84, the sidewalls 86, and the back wall 88 define an area configured to load/unload the nose gear 4 of the airplane 2 onto/from the cradle 82, space the nose gear 4 from the ground surface, and support the nose gear 4 during transportation of the tractor 10 and the airplane 2 being towed or pushed thereby.

As shown in FIGS. 2, 5, and 6, the bottom plate 84 extends within a substantially horizontal plane (e.g., when the cradle 82 is positioned to receive or unload the airplane 2 therefrom). The bottom plate 84 is configured to support the wheels 6 of the nose gear 4 of the airplane 2 during towing and pushback operations of the tractor 10. The bottom plate 84 provides a surface (e.g., a ramp) for the wheels 6 of the nose gear 4 to contact during winching operations to facilitate loading the nose gear 4 of the airplane 2 onto and unloading the nose gear 4 of the airplane 2 from the cradle 82. In some embodiments, the cradle assembly 80 includes a wear plate positioned between the bottom plate 84 and the ground surface. The wear plate may be configured to contact the ground surface (e.g., instead of the bottom plate 84 contacting the ground surface) to prevent wear on the bottom plate 84. The wear plate may be selectively coupled to the bottom plate 84 or another component of the cradle 82 to facilitate replacing the wear plate after repeated use thereof (e.g., the wear plate may wear away or be damaged due to repeated contact with the ground surface). The wear plate may be manufactured from steel (e.g., abrasion resistant steel, hardened steel, carbon steel, stainless steel, etc.,), a polymer (e.g., ultra-high molecular weight polyethylene, fiberglass-reinforced plastics, etc.), and/or any other material suitable for withstanding abrasions, scrapes, and impacts against the ground surface.

As shown in FIGS. 2, 5, and 6, the sidewalls 86 are coupled to the bottom plate 84 along opposing lateral sides thereof (e.g., the sidewalls 86 are laterally spaced apart from each other by the bottom plate 84) and extend in a substantially vertical direction from the bottom plate 84. The sidewalls 86 may provide support to lateral sides of the nose gear 4 and may provide a barrier (e.g., a stop) to limit rotation of the nose gear 4 (e.g., about the pivot 7) within the cradle 82. By way of example, the sidewalls 86 may be laterally spaced apart (e.g., in a direction between the left side 26 and the right side 28) by a distance at least greater than a lateral width of the nose gear 4 to facilitate loading and unloading the nose gear 4 of the airplane 2 onto and from the cradle 82. In some embodiments, positions of the sidewalls 86 are adjustable to vary the lateral distance therebetween to accommodate for varying sizes of the nose gear 4 of different airplanes 2 (e.g., the lateral distance can be made smaller or larger for an airplane 2 with a smaller or larger nose gear 4). In other embodiments, the cradle 82 includes side plates separate from the sidewalls 86 that are adjustable to vary the lateral distance therebetween to accommodate for variously sized nose gears 4.

As shown in FIGS. 2 and 5, the back wall 88 extends from the bottom plate 84 in a lateral direction between the sidewalls 86. The back wall 88 is configured to provide a barrier (e.g., a stop) to limit longitudinal translation (e.g., in a direction between the front end 22 and the rear end 24) of the nose gear 4 within the cradle 82. By way of example, contact between the nose gear 4 (e.g., the wheels 6 of the nose gear 4) and the back wall 88 limits movement of the nose gear 4 and the airplane 2 in a direction towards the rear end 24. In some embodiments, the cradle 82 includes a front gate pivotably coupled to a front or free edge of the cradle 82 (e.g., a front or free edge of the bottom plate 84) such that (i) when the airplane 2 is supported by the cradle 82, the front gate pivots to a position to limit movement of the nose gear 4 and the airplane 2 off of the cradle 82 (e.g., in a direction away from the front end 22) and (ii) during loading and unloading operations, the front gate pivots to a position to permit movement of the nose gear 4 (e.g., does not block or limit the nose gear 4 of the airplane 2 from being loaded or unloaded from the cradle 82). In some embodiments, the front gate provides a ramped surface to facilitate (i) loading the nose landing gear 4 of the airplane 2 onto the bottom plate 84 from the ground surface and (ii) unloading the nose landing gear 4 of the airplane 2 off of the bottom plate 84 and onto the ground surface.

As shown in FIGS. 2 and 5, the cradle assembly 80 includes a winch shutoff plate, shown as switch plate 90, pivotably coupled to the cradle 82 at or proximate the back wall 88. The switch plate 90 may be coupled with a limit switch (e.g., the sensor 438, a position sensor, a mechanical switch, etc.) configured to detect a position of the switch plate 90. By way of example, when the nose gear 4 comes into contact with the switch plate 90, the switch plate 90 pivots and comes into contact or otherwise engages with the limit switch. In such an example, responsive to engagement of the limit switch, a determination may be made that the nose gear 4 is fully loaded onto the cradle 82 and winching operations may be stopped (e.g., automatically stopped). In some embodiments, the cradle assembly 80 does not include the switch plate 90 and/or the limit switch.

As shown in FIGS. 2 and 5, the cradle assembly 80 includes one or more actuators (e.g., hydraulic cylinders, pneumatic cylinders, electric actuators, motor-driven leadscrews, etc.), shown as lift actuators 92, configured to extend and retract to selectively raise (e.g., and thus raise the nose gear 4 when received by the cradle 82) and lower (e.g., and thus lower the nose gear 4 when received by the cradle 82) the cradle 82. As shown in FIGS. 2 and 5, the cradle 82 is pivotably coupled with the body 20 of the tractor 10 by one or more pivot pins (e.g., a shaft, a fastener, etc.), shown as pins 94. A first one of the pins 94 is configured to extend through an aperture of a first one of the sidewalls 86 and a second one of the pins 94 is configured to extend through an aperture of a second one of the sidewalls 86 to rotatably couple the cradle 82 with the body 20. In some embodiments, a single pin 94 is configured to extend through each of the aperture of the first one of the sidewalls 86 and the aperture of the second one of the sidewalls 86 to rotatably couple the cradle 82 with the body 20. In other embodiments, the cradle 82 is otherwise rotatably coupled with the body 20.

As shown in FIGS. 2 and 5, the lift actuators 92 are coupled between the cradle 82 and the frame 12. Specifically, one end (e.g., an outer end) of the lift actuators 92 is coupled (e.g., pivotably coupled) to exterior facing surfaces of the sidewalls 86 (e.g., surfaces of the sidewalls 86 facing the left side 26 and the right side 28, respectively) by a bracket, shown as actuator bracket 96, and an opposite end (e.g., a base end) of the lift actuators 92 is coupled to the frame 12. In this manner, extension of the lift actuators 92 to an extended position, which corresponds with a first, raised position of the cradle 82, pivots the cradle 82 relative to the frame 12 and the body 20 about the pins 94 and raises the cradle 82 to space the bottom plate 84 from the ground surface. Similarly, retraction of the lift actuators 92 to a retracted position, which corresponds with a second, lowered position of the cradle 82, pivots the cradle 82 relative to the frame 12 and the body 20 about the pins 94 (e.g., from the first, raised position to the second, lowered position) and lowers the cradle 82 such that the bottom plate 84 (e.g., or the wear plate) contacts the ground surface. In some embodiments, gravity and/or a weight of the cradle 82 retracts the lift actuators 92. In some embodiments, the cradle assembly 80 includes more or fewer than two of the lift actuators 92. The tractor 10 may include various components to drive the lift actuators 92 (e.g., pumps, valves, compressors, motors, batteries, voltage regulators, powered by electricity provided by the energy storage 54, etc.).

As shown in FIGS. 2, 5, and 6, the winch assembly 100 includes a drive system (e.g., electric motor, internal combustion engine, a hydraulically-operated motor, etc.), shown as motor 102, a drum (e.g., reel, spool, spindle, etc.), shown as winch drum 104, operatively coupled with the motor 102, a cable (e.g., tow rope, chain, tow strap, etc.), shown as winch strap 106, configured to wind about and unwind from the winch drum 104, a coupler (e.g., engagement feature), shown as winch hook 108, positioned at a free end of the winch strap 106 (e.g., a free end of the winch strap 106 opposite an end coupled to the winch drum 104), an airplane engagement feature (e.g., nose gear coupler, strut strap, linkage, etc.), shown as airplane coupler 110, coupled with the winch hook 108, and a hook and coupler storage compartment (e.g., bin, rack, hook, etc.), shown as storage compartment 112.

The motor 102 is configured to provide rotational energy to the winch drum 104 to rotate the winch drum 104. The winch strap 106 is coupled with the winch drum 104 (e.g., at an end of the winch strap 106 opposite the free end at which the winch hook 108 is positioned) and configured to wind around and unwind from the winch drum 104 as the winch drum 104 is driven by the motor 102. By way of example, responsive to the motor 102 providing rotational energy to rotate the winch drum 104 in a first direction, the winch strap 106 is unwound (e.g., paid out, let out, etc.) from the winch drum 104. By way of another example, responsive to the motor 102 providing rotational energy to rotate the winch drum 104 in a second direction opposite the first direction, the winch strap 106 is wound around (e.g., taken up by) the winch drum 104. In some embodiments, the motor 102 is configured to vary the rate at which the winch strap 106 is wound or unwound from the winch drum 104 by adjusting the rotational energy (e.g., the voltage) supplied to the winch drum 104. In some embodiments, the winch-capture system 72 includes a gear box (e.g., a transmission) configured to facilitate adjusting the output speed and torque for rotating the winch drum 104.

As shown in FIGS. 2 and 5, the motor 102 and the winch drum 104 are positioned within an interior chamber of the body 20. The winch strap 106 is configured to extend outside of the body 20 from the winch drum 104. As shown in FIGS. 2 and 5, the free end of the winch strap 106 to which the winch hook 108 is coupled extends outside of the body 20 through a winch aperture defined thereby. The winch hook 108 is configured as a hook (e.g., a carabiner) defining an interface configured to selectively couple with the airplane coupler 110. As shown in FIG. 5, the airplane coupler 110 is configured as a strut strap where ends thereof are configured to be engaged by the interface of the winch hook 108 such that the ends of the airplane coupler 110 are received within an aperture of the winch hook 108 to couple the airplane coupler 110 with the winch hook 108. One of the ends of the airplane coupler 110 may be released from the aperture (e.g., not coupled with the winch hook 108) to facilitate securing the airplane coupler 110 and the winch-capture system 72 to the airplane 2. By way of example, after decoupling a respective end of the airplane coupler 110 from the winch hook 108, the airplane coupler 110 may be wrapped around the pivot 7 of the airplane 2 and the respective end of the airplane coupler 110 may be coupled with the winch hook 108 to couple the nose gear 4 of the airplane 2 with the winch-capture system 72 (e.g., at which point the nose gear 4 of the airplane 2 can be loaded onto or unloaded from the cradle 82). In some embodiments, the airplane coupler 110 is configured as a bracket assembly or a mechanical linkage to engage with the tow element 8 of the airplane 2 to couple the airplane 2 with the winch-capture system 72. In other embodiments, the airplane coupler 110 is otherwise configured to couple with the winch hook 108 to facilitate coupling the airplane 2 with the winch-capture system 72. In yet other embodiments, the winch-capture system 72 omits the airplane coupler 110 and the winch hook 108 engages directly with the tow element 8 or the pivot 7 to couple the nose gear 4 of the airplane 2 with the winch-capture system 72. In some embodiments, the winch-capture system 72 does not include the winch hook 108 such that the airplane coupler 110 is configured to couple the nose gear 4 of the airplane 2 with the winch-capture system 72. In such embodiments, the airplane coupler 110 may be coupled with (e.g., integrally formed with) the winch strap 106 at the free end thereof.

As shown in FIG. 5, the storage compartment 112 is configured to provide a space (e.g., a pocket, a hook, a compartment, etc.) to store or otherwise secure the winch hook 108 and/or the airplane coupler 110 when not in use. The storage compartment 112 facilitates securing the winch hook 108 and/or the airplane coupler 110 to prevent unintentional movement thereof during driving operations of the tractor 10, for example. In some embodiments, the storage compartment 112 is configured to store or otherwise secure a portion of the winch strap 106 (e.g., a portion of the winch strap 106 extending outside of the body 20 and not wound around the winch drum 104) when not in use.

The cradle assembly 80 is configured to operate with the winch assembly 100 to facilitate coupling the airplane 2 with the tractor 10 using the capture system 70. To capture (e.g., couple and secure) the airplane 2, the tractor 10 is driven to position the cradle 82 in front of the nose gear 4, and the cradle 82 is actuated by the lift actuators 92 to the second, lowered position. In the second, lowered position, the cradle 82 (i) is positioned such that the bottom plate 84 (e.g., or the wear plate) contacts the ground surface and (ii) provides a surface (e.g., a ramp) for the nose gear 4 to contact. The motor 102 of the winch assembly 100 drives the winch drum 104 to payout the winch strap 106 with the winch hook 108 and/or the airplane coupler 110 coupled thereto. The winch drum 104 pays out a sufficient length of the winch strap 106 therefrom such that the winch hook 108 and/or the airplane coupler 110 can reach the nose gear 4 and be coupled therewith (e.g., by a coupling with the tow element 8, by a direct coupling with the pivot 7, etc.). With the airplane 2 coupled with the tractor 10 by the winch-capture system 72, and with the cradle 82 in the second, lowered position, the motor 102 drives the winch drum 104 to retract the winch strap 106. Retraction of the winch strap 106 pulls the cradle 82 in a direction towards the airplane 2. In other words, the airplane 2 remains stationary and the tractor 10 travels forward in a direction towards the airplane 2 as the winch strap 106 is retracted such that the bottom plate 84 of the cradle 82 is pulled underneath the wheels 6 of the nose gear 4. In some embodiments, the prime mover 52 provides power to drive the front tractive assembly 56 and/or the rear tractive assembly 58 as the winch strap 106 is being retracted. The motor 102 may continue to provide rotational energy to the winch drum 104 to retract the winch strap 106 until the nose gear 4 is supported and fully received by the cradle 82 (e.g., when the wheels 6 are positioned over the bottom plate 84, when the wheels 6 contact the switch plate 90, when the winch strap 106 is fully retracted, etc.).

In some embodiments, instead of retracting the winch strap 106 such that the airplane 2 remains stationary and the tractor 10 travels forward in a direction towards the airplane 2, retraction of the winch strap 106 pulls the airplane 2 in a direction towards the cradle 82. In other words, the tractor 10 remains stationary and the airplane 2 travels in a direction towards the tractor 10 as the winch strap 106 is retracted such that the wheels 6 of the nose gear 4 are pulled over the top of the bottom plate 84 of the cradle 82. In such embodiments, prior to retracting the winch strap 106 to pull the airplane 2, the braking system 60 may be engaged to prevent rotation of the tractive elements of the front tractive assembly 56 and/or the rear tractive assembly 58 to prevent movement of the tractor 10.

After the nose gear 4 is received by and loaded onto the cradle 82, the lift actuators 92 may extend to transition the cradle 82 from the second, lowered position to the first, raised position. In the first, raised position, the cradle 82 lifts and spaces the nose gear 4 from the ground surface. With the airplane 2 secured to the tractor 10 by the winch-capture system 72 and the cradle assembly 80 supporting the nose gear 4 off of the ground surface, and when the tractor 10 is driven, the winch-capture system 72 facilities pushing or pulling the airplane 2 with the tractor 10 to tow, push, and otherwise reposition the airplane 2. In this manner, responsive to the tractor 10 being driven, the winch-capture system 72 (e.g., the winch hook 108, the airplane coupler 110, the cradle 82, etc.) exerts a force on the airplane 2 such that the airplane 2 is driven at the same speed, in the same direction, and is maintained at a fixed distance from the tractor 10. In some embodiments, when the tractor 10 turns, the wheels 6 pivot relative to the fuselage of the airplane 2 and exert a force on the airplane 2 to pull the airplane 2 in the direction of the tractor 10. In other embodiments, when the tractor 10 turns, the wheels 6 remain fixed relative to the fuselage of the airplane 2.

To unload the airplane 2 from the tractor 10, the cradle 82 is transitioned (e.g., lowered) from the first, raised position to the second, lowered position. The winch-capture system 72 may disengage such that rotation of the winch drum 104 is not inhibited (e.g., the winch drum 104 is free to rotate and pay out the winch strap 106 therefrom). When the winch-capture system 72 is disengaged, and the cradle 82 is in the second, lowered position, the tractor 10 may drive in a direction away from the airplane 2 (e.g., rearward in a direction toward the rear end 24) such that the nose gear 4 is unloaded from the cradle 82. In other words, the airplane 2 remains stationary and the tractor 10 travels rearward or away from the nose gear 4. In some embodiments, the winch strap 106 is paid out by the motor 102 from the winch drum 104 before the nose gear 4 is unloaded from the cradle 82 or as the nose gear 4 is being unloaded from the cradle 82. The airplane coupler 110 can then be decoupled from the nose gear 4.

### Hands-Free Capture System

In some embodiments, the tractor 10 does not include the winch-capture system 72, but rather the tractor 10 includes the hands-free capture system 200. The hands-free capture system 200 may include a second aircraft support assembly or cradle assembly, a shaft, a plurality of arms, and a plurality of actuators. Such components may be used to engage with and secure the nose landing gear 4 to the tractor 10 without requiring an operator to manually interact with the nose gear 4 of the airplane 2. The plurality of arms may be pivotably coupled to opposing ends of the shaft. The plurality of actuators may be configured to pivot, extend, and retract the plurality of arms relative to the tractor 10 and the shaft. The plurality of arms may be configured to selectively engage with the nose gear 4 to couple the nose gear 4 with the tractor 10 with the airplane 2. By way of example, the plurality of arms and the cradle may include engagement features configured to engage with the rear and/or front of the wheels 6.

### Control System

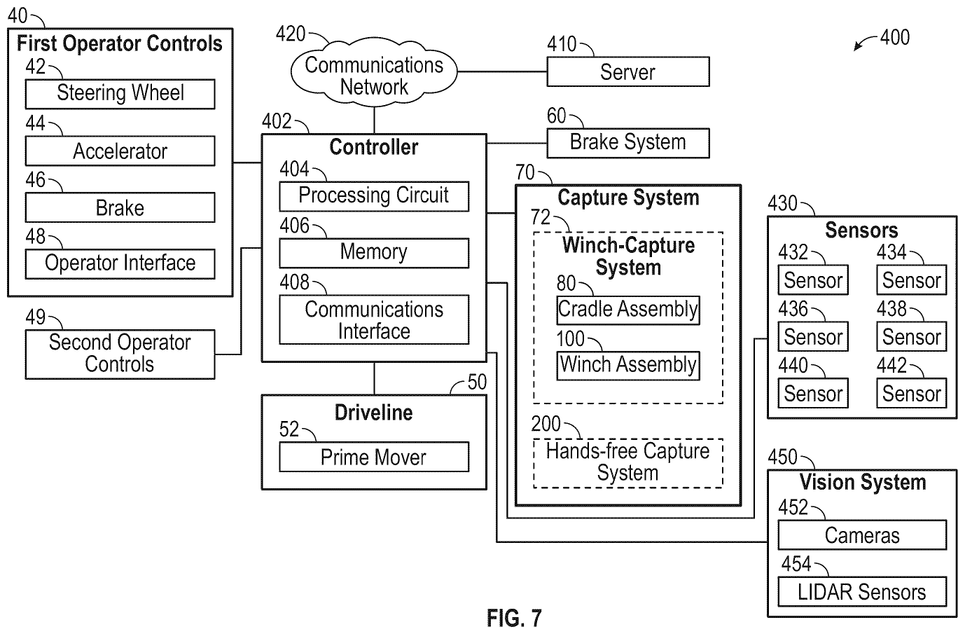

As shown in FIG. 7, the tractor control system 400 includes the first operator controls 40, the second operator controls 49, a controller 402, a remote system, shown as server 410, positioned remote or separate from the tractor 10, one or more first sensors, shown as sensors 430; and a monitoring system, shown as vision system 450. The controller 402 and the server 410 are configured to communicate via one or more communications protocols (e.g., Bluetooth, Wi-Fi, cellular, radio, through the Internet, etc.) through a network, shown as communications network 420.

As shown in FIG. 7, the controller 402 includes a processing circuit 404, a memory 406, and a communications interface 408. The controller 402 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. The processing circuit 404 may include an ASIC, one or more FPGAs, a DSP, circuits containing one or more processing components, circuitry for supporting a microprocessor, a group of processing components, or other suitable electronic processing components. In some embodiments, the processing circuit 404 is configured to execute computer code stored in the memory 406 to facilitate the activities described herein. The memory 406 may be any volatile or non-volatile or non-transitory computer-readable storage medium capable of storing data or computer code relating to the activities described herein. According to an exemplary embodiment, the memory 406 includes computer code modules (e.g., executable code, object code, source code, script code, machine code, etc.) configured for execution by the processing circuit 404. In some embodiments, the controller 402 may represent a collection of processing devices. In such cases, the processing circuit 404 represents the collective processors of the devices, and the memory 406 represents the collective storage devices of the devices.

In one embodiment, the controller 402 is configured to selectively engage, selectively disengage, control, or otherwise communicate with components of the tractor 10 (e.g., via the communications interface 408, a controller area network (“CAN”) bus, etc.). According to an exemplary embodiment, the controller 402 is coupled to (e.g., communicably coupled to) components of the first operator controls 40 (e.g., the steering wheel 42, the accelerator 44, the brake 46, the operator interface 48, etc.), components of the second operator controls 49, components of the driveline 50 (e.g., the prime mover 52), components of the braking system 60, components of the capture system 70 (e.g., the lift actuators 92 of the cradle assembly 80, the motor 102 of the winch assembly 100, the hands-free capture system 200, etc.), the sensors 430, and the vision system 450. By way of example, the controller 402 may send and receive signals (e.g., control signals, location signals, etc.) with the components of the first operator controls 40, the components of the second operator controls 49, the components of the driveline 50, the components of the braking system 60, the components of the capture system 70, the sensors 430, the vision system 450, and/or remote systems or devices (via the communications interface 408) including the server 410. By way of another example, the controller 402 may make determinations and control operation of the one or more components of the tractor 10 responsive to signals received by the sensors 430 and/or the vision system 450 indicative of the data captured thereby.

The sensors 430 may include various sensors positioned about the tractor 10 to acquire tractor information or tractor data regarding operation of the tractor 10 and/or the location thereof. By way of example, the sensors 430 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, and/or other sensors to facilitate acquiring tractor information or tractor data regarding operation of the tractor 10 and/or the location thereof. According to an exemplary embodiment, one or more of the sensors 430 are configured to facilitate detecting and obtaining data relating to the airplane 2 and one or more components thereof including a position of the airplane 2 relative to the tractor 10, a position of the wheels 6 relative to the cradle 82 (e.g., an angle of the wheels 6, a lateral/longitudinal position of the wheels 6 relative to the sidewalls 86 and/or the bottom plate 84, etc.), a type of aircraft (e.g., manufacturer, model, size, etc.), and/or other aircraft data. According to another exemplary embodiment, one or more of the sensors 430 are configured to facilitate detecting and obtaining data relating to the operation of the tractor 10 and one or more components thereof including a position of the cradle 82 (e.g., a distance the cradle 82 is from the ground surface, length of extension of the lift actuators 92, whether the cradle 82 is in the first, raised position or the second, lowered position, etc.), whether the winch hook 108 and/or the airplane coupler 110 are stored inside of the storage compartment 112, a speed of the tractor 10, a position of the tractor 10, and/or other tractor data.

As shown in FIGS. 2, 3, and 7, the sensors 430 include a first sensor (e.g., a limit switch, a position sensor, a mechanical switch, etc.), shown as sensor 432, configured to detect whether an operator is sitting on the seat 36. By way of example, the sensor 432 may be coupled with the seat 36 such that when the operator sits in the seat 36, the seat 36 comes into contact or otherwise engages the sensor 432. Responsive to engagement of the sensor 432, a determination may be made by the controller 402 or the server 410 that the operator is sitting in the seat 36. In some embodiments, the sensor 432 is another type of sensor (e.g., vision sensor, camera, etc.) configured to detect the presence or absence of the operator in the forward travel compartment 32 and/or the rearward travel compartment 34. While only shown as being coupled to one of the seats 36, it should be understood that the sensors 432 may be coupled to both seats 36.

As shown in FIGS. 2, 5, and 7, the sensors 430 include one or more second sensors (e.g., a wheel angle sensor, a potentiometer, a string potentiometer, an accelerometer, an inertial measurement unit, etc.), shown as sensors 434, configured to detect a steering angle of the tractive elements of the front tractive assembly 56 and/or the rear tractive assembly 58. As shown in FIGS. 2 and 5, the sensors 434 are positioned at or proximate the left tractive elements of the front tractive assembly 56 and the right tractive elements of the front tractive assembly 56. In some embodiments, the sensors 434 are additionally or alternatively positioned at or proximate the left tractive elements of the rear tractive assembly 58 and the right tractive elements of the rear tractive assembly 58.

As shown in FIGS. 2, 5, and 7, the sensors 430 include a third sensor (e.g., a nose gear sensor, a proximity sensor, a camera, etc.), shown as sensor 436, configured to detect the position of the nose gear 4 relative to the capture system 70. By way of example, the sensor 436 may be coupled to the cradle 82 at a position corresponding to a position where the nose gear 4 is fully loaded onto the cradle 82 if the sensor 436 detects the nose gear 4. In such an example, responsive to a detection of the nose gear 4 (e.g., the wheels 6) by the sensor 436, a determination may be made by the controller 402 that the nose gear 4 is fully loaded onto the cradle 82. By way of another example, the sensor 436 may be coupled to the hands-free capture system 200 to detect a position of the nose gear 4 relative to the cradle to determine whether the nose gear 4 is in a suitable position to be raised from the ground surface by the cradle. In some embodiments, the sensor 436 is otherwise configured and/or positioned to detect a position of the wheels 6 relative to the capture system 70 (e.g., an angle of the wheels 6, a lateral/longitudinal position of the wheels 6 relative to the sidewalls 86 and/or the bottom plate 84, a position of the plurality of arms and the cradle relative to the wheels 6, etc.).

As shown in FIGS. 2, 5, and 7, the sensors 430 include a fourth sensor (e.g., a switch plate sensor, a position sensor, a mechanical switch, etc.), shown as sensor 438, configured to detect a position of the switch plate 90. By way of example, when the nose gear 4 comes into contact with the switch plate 90, the switch plate 90 pivots and comes into contact or otherwise engages with the sensor 438. In such an example, responsive to engagement of the sensor 438, a determination may be made by the controller 402 that the nose gear 4 is fully loaded by the capture system 70 (e.g., onto the cradle 82 and winching operations may be stopped).

As shown in FIGS. 2, 5, and 7, the sensors 430 include a fifth sensor (e.g., a winch sensor, a load sensor, a position sensor, a speed sensor, etc.), shown as sensor 440, configured to monitor operation of the winch-capture system 72. By way of example, the sensor 440 may include a load sensor or strain gauge configured to monitor the tension or strain on the winch strap 106 during loading and unloading operations. By way of another example, the sensor 440 may include a rotary encoder configured to monitor the rotation of the winch drum 104 to determine a length of the winch strap 106 that has been wound or unwound therefrom and/or a rate at which the winch strap 106 is wound or unwound therefrom.

As shown in FIGS. 2, 5, and 7, the sensors 430 include a sixth sensor (e.g., a winch hook sensor, a position sensor, a proximity sensor, etc.), shown as sensor 442, configured to monitor the position of the winch hook 108 and/or the airplane coupler 110. By way of example, the sensor 442 may be configured to facilitate determining whether the winch hook 108 and/or the airplane coupler 110 is secured by the storage compartment 112. By way of another example, the sensor 442 may be configured to facilitate monitoring the position of the winch hook 108 and/or the airplane coupler 110 to determine whether the winch hook 108 and/or the airplane coupler 110 are sufficiently retracted. In some embodiments, a determination is made that (i) the winch hook 108 and the airplane coupler 110 are sufficiently retracted and/or (ii) the winch hook 108 and/or the airplane coupler 110 are secured using the storage compartment 112 when a mechanical, electromechanical, electrical, magnetic, etc. connection is established between the sensor 442 and the winch hook 108 and/or the airplane coupler 110. By way of example, the connection may be established via physical contact or sufficiently close proximity between the sensor 442 and the winch hook 108 and/or the airplane coupler 110. When the connection is made, a determination may be made by the controller 402 that (i) the winch hook 108 and the airplane coupler 110 are sufficiently retracted and/or (ii) the winch hook 108 and/or the airplane coupler 110 are secured using the storage compartment 112. Monitoring whether the winch hook 108 and the airplane coupler 110 are sufficiently retracted and whether the winch hook 108 and/or the airplane coupler 110 are secured using the storage compartment 112 helps prevent unintentional movement thereof during driving operations of the tractor 10 and may facilitate prevention of driving the tractor 10 without first retracting or winding up the winch hook 108 and/or the airplane coupler 110.

The vision system 450 includes one or more first sensors, shown as cameras 452, and one or more second sensors, shown as LIDAR sensors 454. The cameras 452 and the LIDAR sensors 454 may be variously positioned about the tractor 10 to acquire tractor information or tractor data regarding operation of the tractor 10, operation of the airplane 2, and/or a surrounding environment. The cameras 452 are configured to capture image data including videos and/or still images. The LIDAR sensors 454 are configured to capture distance measurements, three-dimensional maps, perform object detection and recognition, and/or capture other LIDAR data. The image data from the cameras 452 and the LIDAR data from the LIDAR sensors 454 may be transmitted to the operator interface 48 and/or the second operator controls 49 to be displayed on the one or more displays thereof. According to an exemplary embodiment, one or more of the cameras 452 and/or LIDAR sensors 454 are configured to facilitate obtaining data relating to the airplane 2 and one or more components thereof including a position of the airplane 2 relative to the tractor 10, a position of the wheels 6 relative to the capture system 70 (e.g., an angle of the wheels 6, a lateral/longitudinal position of the wheels 6 relative to the sidewalls 86 and/or the bottom plate 84, etc.), a height of a fuselage of the airplane 2, a height of the turbines on the airplane 2, a wing height of the airplane 2, and/or other aircraft image data. According to another exemplary embodiment, one or more of the cameras 452 and/or LIDAR sensors 454 are configured to facilitate obtaining data relating to the operation of the tractor 10 and one or more components thereof including a position of components of the capture system 70 and/or other tractor data. In some embodiments, the cameras 452 and/or LIDAR sensors 454 are configured to continuously capture data or periodically capture data (e.g., take a picture every 1 second, 5 seconds, 30 seconds, etc., record a 30 second, 1 minute, 5 minute, etc., long video every 30 seconds, 1 minute, 5 minutes, etc., capture data every 1 second, 5 seconds, 30 seconds, etc.). The cameras 452 and/or LIDAR sensors 454 may be configured to capture data responsive to an event (e.g., a detection that the tractor 10 crashed, a detection that the airplane 2 crashed, a detection of an improper alignment of the airplane 2 with the capture system 70, a detection that the airplane 2 is not present when it should be present, at the completion of capturing the nose gear 4, etc.) and communicate the data captured before the detection of the event (e.g., 30 seconds before, 1 minute before, 5 minutes before, etc.), after the detection of the event (e.g., 30 seconds after, 1 minute after, 5 minutes after, etc.), and/or during the detection of the event. In some embodiments, the data captured by the vision system 450 is used to autonomously drive the tractor 10 (e.g., with or without the airplane 2 coupled therewith), recognize one or more objects (e.g., recognize an operator, recognize a type of the airplane 2, etc.), detect one or more objects or hazards and control one or more components of the tractor 10 to avoid a collision with the hazard or object, assist the operator to perform one or more functions (e.g., assist in aligning the capture system 70 with the airplane 2), and/or for one or more other processes.

The server 410 may include one or more processors that execute one or more software programs to perform various processes. The server 410 may include processors and non-transitory, computer readable medium including instructions, which, when executed by the processors, cause the processors to perform methods disclosed herein. The processor may include any number of physical, hardware processors. Although FIG. 7 shows only a single server 410, the server 410 may include any number of computing devices. The server 410 may perform all or portions of the processes performed by the controller 402. In other words, any of the functions or processes described herein with respect to the controller 402 may be performed by the controller 402 and/or the server 410. By way of example, data collection may be performed by the controller 402 and data analytics may be performed by the controller 402. By way of another example, data collection may be performed by the controller 402 and data analytics may be performed by the server 410. By way of yet another example, data collection may be performed by the controller 402, a first portion of data analytics may be performed by the controller 402, and a second portion of data analytics may be performed by the server 410. By way of still another example, a first portion of data collection may be performed by the controller 402, a second portion of data collection may be performed by the server 410, and data analytics may be performed by the controller 402 and/or the server 410.

The server 410 may be configured to facilitate operator access to dashboards including the aircraft data, the tractor data, the image data, information available to the controller 402, etc. to manage and operate the tractor 10 such as to control raising and lowering operations of the cradle assembly 80 and/or winching operations of the winch-capture system 72, controlling operations of the hands-free capture system 200, remotely operating the tractor 10, etc. By way of example, the server 410 may be accessible via a user device (e.g., computer, laptop, smartphone, tablet, smart watch, etc.). The server 410 may also be configured to facilitate operator implementation of configurations and/or parameters for the tractor 10 (e.g., setting speed limits, setting wheel angle limits, etc.). Such configurations and/or parameters may be propagated to the controller 402 of the tractor 10 via the communications network 420 (e.g., as updates to settings) and/or used for real time control of the tractor 10 by the server 410.

### Tractor Control Based on Steering Angle

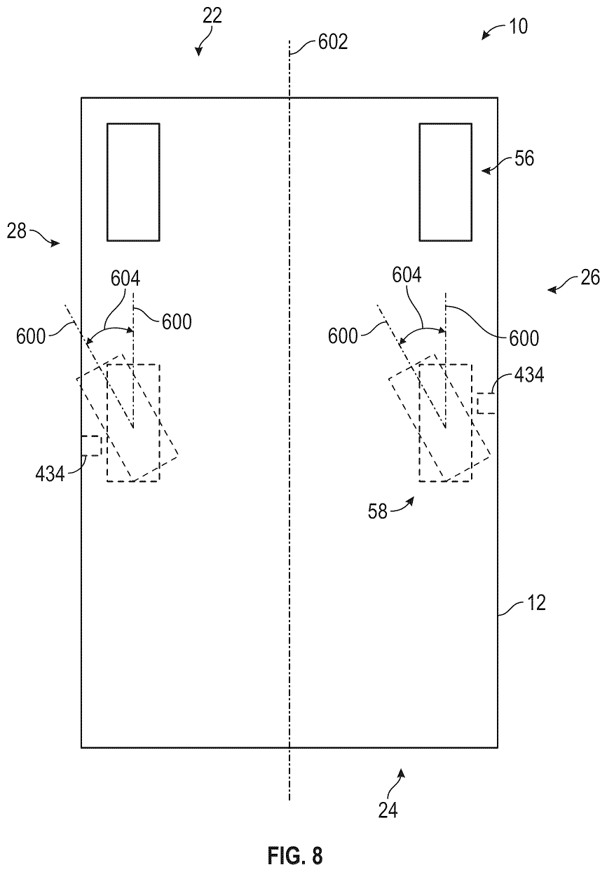

As shown in FIG. 8, the tractive elements of the rear tractive assembly 58 define an axis, shown as wheel axis 600. When the tractive elements of the rear tractive assembly 58 are straight (e.g., not angled, not steered, in a home or nominal position, etc.), the wheel axis 600 is substantially parallel with a longitudinal axis of the tractor 10, shown as tractor axis 602. An angle, shown as steering angle 604, of the tractive elements of the rear tractive assembly 58 is defined as an angle between the wheel axis 600 when the tractive elements of the rear tractive assembly 58 are angled and the wheel axis 600 when the tractive elements of the rear tractive assembly 58 are straight (e.g., not angled, parallel with the tractor axis 602). In some embodiments, the steering angle 604 is defined as an angle between the wheel axis 600 and the tractor axis 602. By way of example, when the tractive elements of the rear tractive assembly 58 are straight, the steering angle 604 is about 0 degrees (e.g., 0.5 degrees, 1 degree, 0 degrees, 2 degrees, etc.). In some embodiments, the maximum steering angle 604 of the tractive elements of the rear tractive assembly 58 is about ±70 degrees (e.g., ±70.5 degrees, ±71 degrees, ±75 degrees, ±65 degrees, etc.). In other embodiments, the maximum steering angle is less than or greater than ±70 degrees (e.g., ±45 degrees, ±50 degrees, ±60 degrees, ±80 degrees, ±85 degrees, etc.). In some embodiments, the rear tractive assembly 58 includes an angle limiter (e.g., a mechanical stop) configured to limit the steering angle 604 to a desired maximum steering angle. The desired maximum steering angle may be adjustable. In some embodiments, the controller 402 is configured control operation of the rear tractive assembly 58 to limit the steering angle 604 to a desired or preset maximum steering angle.

As shown in FIG. 8, the sensors 434 are positioned at or proximate the left tractive elements of the rear tractive assembly 58 and the right tractive elements of the rear tractive assembly 58. The sensors 434 are configured to detect the steering angle 604 of the tractive elements of the rear tractive assembly 58. In some embodiments, the sensors 434 are additionally or alternatively positioned at or proximate the left tractive elements of the front tractive assembly 56 and the right tractive elements of the front tractive assembly 56 and are configured to detect the steering angle 604 of the tractive elements of the front tractive assembly 56 (e.g., in configurations in which the front tractive assembly 56 is steerable). In some embodiments, the sensors 434 include a linear displacement sensor coupled to a steering cylinder and configured to extend with the steering cylinder to determine the steering angle 604. By way of example, as the tractive elements turn, the steering cylinder and the linear displacement sensor linearly extend, and the linear extension of the steering cylinder detected by the linear displacement sensor corresponds with the steering angle 604 (e.g., the linear displacement sensor measures a voltage between 0 Volts and 5 Volts that varies with the linear displacement of the steering cylinder and which can be used to determine the steering angle 604). In some embodiments, the sensors 434 include a string potentiometer coupled with the rear tractive assembly 58 (and/or the front tractive assembly 56) and are configured to facilitate determining the steering angle 604. By way of example, the string potentiometer may be configured to count revolutions (e.g., of a spool about which a string is wound) corresponding to the steering angle 604. In some embodiments, the sensors 434 include a potentiometer and/or a Hall effect sensor positioned on kingpins of the rear tractive assembly 58 (and/or the front tractive assembly 56) that are positioned to facilitate determining the steering angle 604. In some embodiments, the sensors 434 include an accelerometer and/or an inertial measurement unit (including accelerometers, gyroscopes, magnetometers, etc.) configured to detect orientations of and acceleration/forces experienced by the tractor 10, which may correspond to or be impacted by the steering angle 604 (and speed of the tractor 10). In some embodiments, the sensors 434 include a sensor configured to facilitate detection or monitoring a steering angle or position of the steering wheel 42.

The steering angle 604 may be monitored and utilized to control and manage the tractor 10 during driving operations (e.g., while towing the airplane 2, while not towing the airplane 2, etc.). The controller 402 is configured to monitor or determine the steering angle 604 and a current speed of the tractor 10, and selectively control (e.g., reduce) a maximum speed of the tractor 10 based on the steering angle 604 and the current speed. By way of example, if the sensors 434 indicate that the rear tractive assembly 58 (or the front tractive assembly 56) is steered (e.g., angled) at the steering angle 604 beyond a threshold steering angle (e.g., the steering angle 604 exceeds a threshold steering angle) when the tractor 10 is traveling at or faster than a predetermined speed (e.g., a steering angle 604 appropriate for the speed at which the tractor 10 is traveling, a threshold speed, etc.), the controller 402 may limit operation (e.g., limit operation of the tractor 10 in a second mode of operation) of the first operator controls 40, the driveline 50, the braking system 60, the capture system 70, and/or any other component of the tractor 10. In such an example, the controller 402 may (i) limit operation of the prime mover 52 such that the tractor 10 cannot exceed a threshold speed (e.g., the predetermined speed, 5 miles per hour, 2 miles per hour, etc.), (ii) engage the braking system 60 to reduce the speed of the tractor 10 to or below the threshold speed, (iii) limit operation of the steering wheel 42 such that the rear tractive assembly 58 (or the front tractive assembly 56) cannot exceed a threshold steering angle, and/or (iv) any other control to limit operation of the tractor 10. In such an example, to transition the tractor 10 to the second mode of operation (e.g., from a first, unrestricted mode of operation), the controller 402 may (i) shift the tractor 10 into neutral (e.g., such that no power is transmitted to the prime mover 52), (ii) throttle or limit the output of the prime mover 52, and/or (iii) operate the braking system 60 to slow the tractor 10.

Generally, as the steering angle 604 increases, the threshold speed at or below which the tractor 10 is permitted to travel (and above which the tractor 10 is limited to the second mode of operation) decreases. Accordingly, the driveline 50 may be controlled to dynamically limit or reduce a maximum speed of the tractor 10 based on the current speed and the steering angle. In some embodiments, the threshold speed decreases linearly with the steering angle 604 as the steering angle 604 increases. In some embodiments, the threshold speed decreases non-linearly (e.g., according to a curvilinear function) with the steering angle 604 as the steering angle 604 increases. In some embodiments, the threshold speed decreases at different linear rates at different increasing ranges of the steering angle 604. By way of example, (i) across a first range of the steering angle 604 (e.g., between about 0 degrees and about ±20 degrees), the threshold speed may decrease with an increasing steering angle 604 according to a first linear rate or slope (or according to a curvilinear function), (ii) across a second range of the steering angle 604 (e.g., the second range greater than the first range, between about ±20 degrees and about ±40 degrees, etc.), the threshold speed may decrease with an increasing steering angle 604 according to a second linear rate or slope that is greater than the first linear rate or slope, and (iii) across a third range of the steering angle 604 (e.g., the third range greater than the second range, between about ±40 degrees and about ±70 degrees, etc.), the threshold speed may decrease with an increasing steering angle 604 according to a third linear rate or slope that is greater than the second linear rate or slope. It should be understood that the threshold speed may decrease according to any linear or non-linear function, or combination thereof with an increasing steering angle 604.

As one example, if the tractor 10 is stationary and an operator turns the steering wheel 42 to the maximum steer angle (i.e., a steer lock scenario), the controller 402 may be configured to prevent the prime mover 52 from exceeding a steer lock threshold speed. Such speed limiting will prevent the operator from inappropriately operating the tractor 10 (i.e., prevent a high-speed donut-like operation). As another example, if the tractor 10 is moving and an operator turns the steering wheel 42, the controller 402 may be configured to limit or reduce the output of the prime mover 52 and/or engage the braking system 60 to slow the tractor 10 as the steering wheel 42 is turned depending on the current speed of the tractor 10 and the steering angle 604. For example, if the operator turns the steering wheel 42 a large amount while the tractor 10 is traveling at a low speed, the controller 402 may be configured to not limit or reduce the output of the prime mover 52 and/or engage the braking system 60. As another example, if the operator turns the steering wheel 42 a small amount while the tractor 10 is traveling at a high speed, the controller 402 may be configured to not limit or reduce the output of the prime mover 52 and/or engage the braking system 60. As another example, if the operator turns the steering wheel 42 a large amount while at the tractor 10 is traveling a medium speed, the controller 402 may be configured to slightly limit or reduce the output of the prime mover 52 and/or engage the braking system 60. As another example, if the operator turns the steering wheel 42 a large amount while at the tractor 10 is traveling a high speed, the controller 402 may be configured to considerably limit or reduce the output of the prime mover 52 and/or engage the braking system 60.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled,” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the tractor 10 and the systems and components thereof as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A vehicle for towing an airplane having a nose gear, the vehicle comprising:
a chassis;
a front tractive assembly;
a rear tractive assembly, wherein at least one of the front tractive assembly or the rear tractive assembly is a steerable tractive assembly;
a driveline configured to drive and brake at least one of the front tractive assembly or the rear tractive assembly;
a capture system configured to engage with the nose gear; and
a control system configured to:
monitor a current speed of the vehicle;
determine a steering angle of the steerable tractive assembly; and
limit operation of the vehicle based on the current speed and the steering angle.

2. The vehicle of claim 1, further comprising a steering sensor positioned on or proximate the steerable tractive assembly, wherein the control system is configured to determine the steering angle based on data acquired by the steering sensor.

3. The vehicle of claim 1, further comprising a steering sensor positioned to detect a steering position of a steering wheel of the vehicle used to control the steerable tractive assembly, wherein the control system is configured to determine the steering angle based on data acquired by the steering sensor.

4. The vehicle of claim 1, further comprising an accelerometer or an inertial measurement unit, wherein the control system is configured to determine the steering angle based on data acquired by the accelerometer or the inertial measurement unit.

5. The vehicle of claim 1, wherein the control system is configured to:
monitor the current speed of the vehicle relative to a speed threshold; and
limit operation of the vehicle when the current speed exceeds the speed threshold.

6. The vehicle of claim 5, wherein as the steering angle increases, the speed threshold decreases.

7. The vehicle of claim 1, wherein the control system is configured to:
monitor the steering angle of the steerable tractive assembly relative to a steering angle threshold; and
limit operation of the vehicle when the steering angle exceeds the steering angle threshold.

8. The vehicle of claim 1, wherein limiting operation of the vehicle includes controlling the driveline to limit or reduce a maximum speed of the vehicle.

9. The vehicle of claim 1, wherein limiting operation of the vehicle includes limiting a steering wheel angle of a steering wheel of the vehicle used to control the steerable tractive assembly.

10. The vehicle of claim 1, wherein the rear tractive assembly is the steerable tractive assembly.

11. A tow vehicle system comprising:
one or more processing circuits configured to:
monitor a current speed of a tow vehicle configured to tow an airplane having a nose gear, the tow vehicle including a steerable tractive assembly and a driveline configured to drive and brake the tow vehicle;
determine a steering angle of the steerable tractive assembly; and
control the driveline to dynamically limit or reduce a maximum speed of the tow vehicle based on the current speed and the steering angle.

12. The tow vehicle system of claim 11, wherein the one or more processing circuits are configured to:
monitor the current speed of the tow vehicle relative to a speed threshold; and
limit operation of the tow vehicle when the current speed exceeds the speed threshold.

13. The tow vehicle system of claim 12, wherein the one or more processing circuits are configured to:
monitor the steering angle of the steerable tractive assembly relative to a steering angle threshold; and
limit operation of the tow vehicle when the steering angle exceeds the steering angle threshold.

14. The tow vehicle system of claim 13, wherein as the steering angle increases, the speed threshold decreases.

15. The tow vehicle system of claim 11, wherein the one or more processing circuits include at least one of (i) a first processing circuit located on the tow vehicle or (ii) a second processing circuit located remote from the tow vehicle.

16. A vehicle for towing an airplane having a nose gear, the vehicle comprising:
a chassis;
a front tractive assembly;
a rear tractive assembly, wherein at least one of the front tractive assembly or the rear tractive assembly is a steerable tractive assembly;
a driveline configured to drive and brake at least one of the front tractive assembly or the rear tractive assembly;
a capture system configured to engage with the nose gear; and
a control system configured to:
monitor a current speed of the vehicle;
determine a steering angle of the steerable tractive assembly; and
control the driveline to dynamically limit or reduce a maximum speed of the vehicle based on the current speed and the steering angle.

17. The vehicle of claim 16, further comprising a steering sensor positioned on or proximate the steerable tractive assembly, wherein the control system is configured to determine the steering angle based on data acquired by the steering sensor.

18. The vehicle of claim 16, further comprising a steering sensor positioned to detect a steering position of a steering wheel of the vehicle used to control the steerable tractive assembly, wherein the control system is configured to determine the steering angle based on data acquired by the steering sensor.

19. The vehicle of claim 16, further comprising an accelerometer or an inertial measurement unit, wherein the control system is configured to determine the steering angle based on data acquired by the accelerometer or the inertial measurement unit.

20. The vehicle of claim 16, wherein as the steering angle increases, the maximum speed decreases.
